(19) United States
(12) Patent Application Publication
(10) Pub. No.: US 2008/0285470 A1
(43) Pub. Date: Nov. 20, 2008

(54) Determining An Active/Standby State From Service Readiness

(76) Inventors: Catherine Yuan, Plano, TX (US); Yangbing Li, Plano, TX (US); Milind Kulkarni, Richardson, TX (US); Raghu Rajan, Plano, TX (US); Vikas Mittal, Wylie, TX (US)

Correspondence Address: BAKER BOTTS L.L.P., 2001 ROSS AVENUE, SUITE 600, DALLAS, TX, 75201-2980, US

(21) Appl. No.: 11/750,446

(22) Filed: May 18, 2007

(51) Int. Cl. G06F 11/30

(52) U.S. Cl. 370/248

(57) ABSTRACT

Determining an active/standby state of one or more modules of a network element includes provisioning a path through the modules, where the path is for providing a service. A signal is introduced into the path, and the path is monitored. The service is established to be ready in accordance with the monitoring. The modules are determined to be in an active state in response to establishing that the service is ready.

### TECHNICAL FIELD

This invention relates generally to the field of communication networks and more specifically to determining an active/standby state from service readiness.

### BACKGROUND

A module of a network element may have an active/standby state that indicates whether the module is in an active or standby state. For example, a network element may have a shelf with line cards that perform various operations for the element. A line card may have a particular active/standby state that indicates whether the line card in an active or standby state. An active state may indicate that the line card is in use, and a standby state may indicate that the line card is not in use, but is ready to be put into use.

### SUMMARY OF THE DISCLOSURE

In accordance with the present invention, disadvantages and problems associated with previous techniques for determining an active/standby state for modules of a network element may be reduced or eliminated.

According to one embodiment of the present invention, determining an active/standby state of one or more modules of a network element includes provisioning a path through the modules, where the path is for providing a service. A signal is introduced into the path, and the path is monitored. The service is established to be ready in accordance with the monitoring. The modules are determined to be in an active state in response to establishing that the service is ready.

Certain embodiments of the invention may provide one or more technical advantages. A technical advantage of one embodiment may be that service readiness of a network element may be used to determine the active/standby states for modules of the network element. A path for providing the service may be provisioned and monitored. When the service is ready, the modules of the path may be designated to have an active state. Another technical advantage of one embodiment may be that the facilities of a module of the path providing a service that is ready may also be determined to have an active state.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a portion of a network system that includes modules for which an active/standby state may be determined;

FIG. 2 illustrates one embodiment of a network element that may be used with the network system portion of FIG. 1; and

FIG. 3 illustrates one embodiment of a method for establishing active/standby states from service readiness that may be used with the network element of FIG. 2.

### DETAILED DESCRIPTION OF THE DRAWINGS

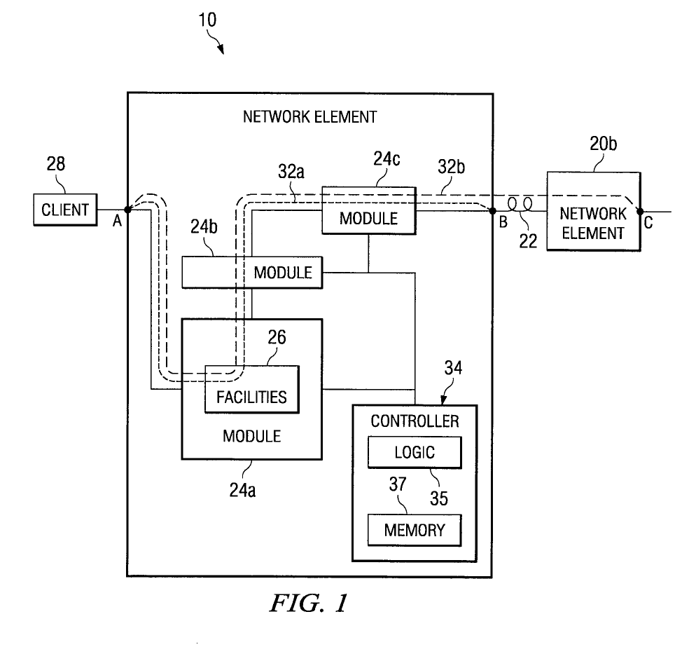

Embodiments of the present invention and its advantages are best understood by referring to FIGS. 1 through 3 of the drawings, like numerals being used for like and corresponding parts of the various drawings.

FIG. 1 illustrates one embodiment of a portion 10 of a network system that includes modules 24 for which an active/standby state may be determined. According to the embodiment, service readiness may be used to determine the active/standby states for modules 24. A path 32 through modules 24 providing the service may be provisioned and monitored. When the service is ready, modules 24 may be designated to have an active state. Facilities 26 of a module 24a may also be determined to have an active state.

Network system portion 10 communicates information through signals. Information may include voice, data, audio, video, multimedia, control, signaling, other information, or any combination of the preceding. A signal may refer to an optical signal transmitted as light pulses. As an example, an optical signal may have a frequency of approximately 1550 nanometers and a data rate of 10, 20, 40, or over 40 gigabits per second. A signal may comprise a synchronous transport signal (STS) that communicates information in packets.

According to one embodiment, portion 10 may be a part of a ring network, such as an optical ring network with optical fibers. A ring network may include nodes coupled by fibers in a ring topology, for example, a unidirectional path-switched ring (UPSR) topology or a bidirectional line switched ring (BLSR) topology. A ring network may utilize protocols such as Resilient Packet Ring (RPR) protocols, in which packets are added, passed through, or dropped at each node. According to one embodiment, ring network may utilize any suitable transmission technique, such as Ethernet, Synchronous Optical Network (SONET), or wavelength division multiplexing (WDM) (such as dense wavelength division multiplexing (DWDM)) techniques.

According to the illustrated embodiment, portion 10 includes network elements 20a-b, fibers 22, a client 28, and paths 32 coupled as shown. A network element 20a includes a modules 24a-c and a controller 34, and a module 24a includes a facility 26. Controller 34 includes logic 35 and a memory 37. Path 32a couples points A and B, and path 32b couples points A and C.

Network element 20a-b represent any suitable device operable to route signals to or from the network system. Examples of network elements 20 include dense wavelength division multiplexers (DWDMs), optical add/drop multiplexers (OADMs), access gateways, endpoints, softswitch servers, trunk gateways, access service providers, Internet service providers, or other device operable to route packets to or from ring network.

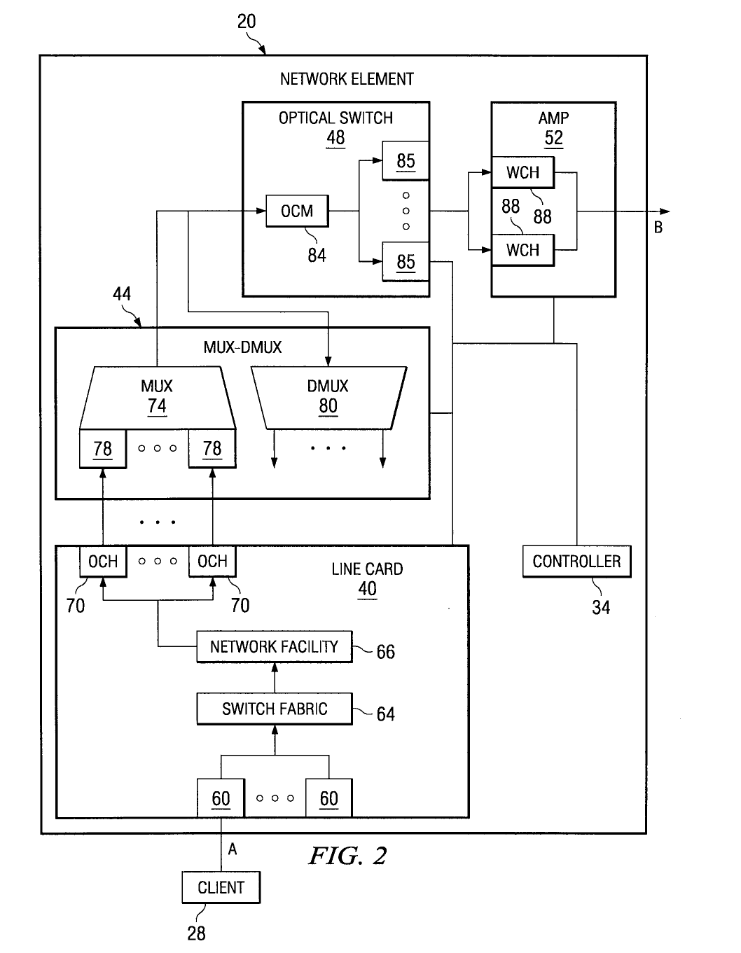

Modules 24 comprise logic (such as software and/or hardware) of network element 20 that process signals to performs the operations of network element 20. Examples of modules 24 are described in more detail with reference to FIG. 2. A module 24 may include other modules 24 such as facilities 26. A facility 26 supports traffic for a specific service. Examples of facilities 26 are described in more detail with reference to FIG. 2.

According to one embodiment, a module 24 may have an active/standby state. The active/standby state may indicate whether module 24 is in an active state or a standby state. Module 24 may be in an active state when module 24 is in use, and may be in standby state when module 24 is not ready for use.

Path 32 comprises medium operable to communicate a signal from one end of path 32 to the other end of path 32. The medium may include connections within or between modules 24. A service communicates signals along a path 32, and may be designated as ready when path 32 is operable to communicate signals.

Client 28 represents any suitable computer or computer or computer system operable to communicate signals to/from network element 20. Client 28 uses network element 20 to send signals to the network system or receive signals from the network system.

Controller 34 performs operations to manage network element 20, and may comprise a network element management card. For example, controller 34 performs configuration, provisioning, and/or monitoring operations. Controller 34 includes logic 35 operable to perform the functions of controller 34 and a memory 37 operable to store information relevant to the functions of controller 34, such as information about modules 24 of a path 32.

According to one embodiment, controller 34 provisions a path 32 to provide a service by establishing connections operable to communicate signals from the start to end of path 32. A connection may be established by mapping ports. For example, path 32 between modules 24a-b may be provisioned by mapping a first port of a first module 24a to a second port of a second module 24b to allow signals to travel from the first port to the second port.

According to one embodiment, controller 34 determines active/standby states for modules 24. In the embodiment, controller 34 provisions path 32a from A to B through modules 24 to set up a service and sends a signal through input A. Controller 34, in cooperation with optical channel monitor 34, monitors path 32a and establishes whether a condition affects service, such as affects or even disrupts packet flow. If there is a condition, controller 34 may resolve the condition, example, may determine whether path 32a was provisioned properly. Once conditions have been resolved, controller 34 determines that the service is ready.

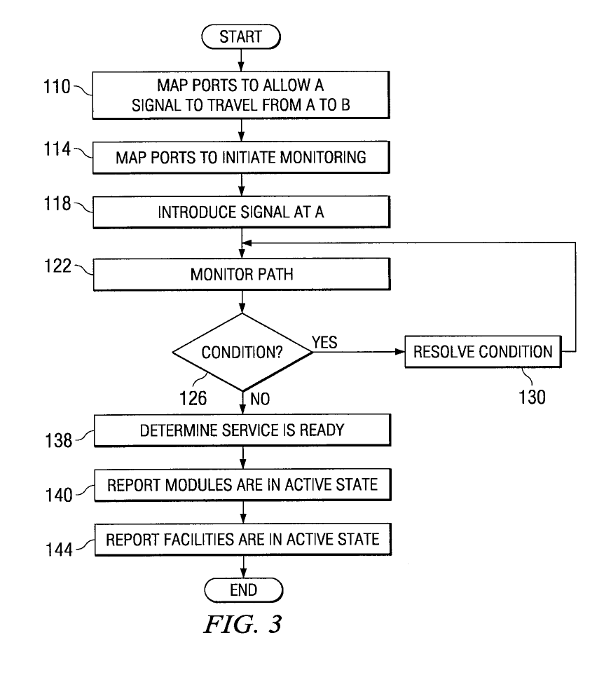

If a service is ready, then modules 24 of path 32 providing the service may be determined to have active states. Otherwise, modules 24 may be determined to have a standby state. For example, if the service provided by path 32a is ready, then modules 24a-c may be determined to have an active state. Otherwise, the modules 24a-c may be determined to have standby states. An example of operations performed by controller 34 is described in more detail with reference to FIG. 3.

Controller 34 may perform other suitable operations to configure, provision, and/or monitor network element 20. As an example, controller 34 may receive instructions from a user through a user interface, and may implement the instructions to configure, provision, and/or monitor network element 20. As another example, controller 84 may provide configuration, provisioning, and/or monitoring information about network element 20 to other components of a network system.

A component of portion 10 may include any suitable parts operable to perform the operations of the component, such as logic, an interface, memory, other component, or any suitable combination of the preceding. “Logic” may refer to hardware, software, other logic, or any suitable combination of the preceding. Logic may be embodied in a computer-readable medium and operable to perform functions when executed by a computer. Certain logic may manage the operation of a device, and may comprise, for example, a processor. “Processor” may refer to any suitable device operable to execute instructions and manipulate data to perform operations.

“Interface” may receive input for the device, send output from the device, perform suitable processing of the input and/or output, or any combination of the preceding, and may comprise one or more ports and/or conversion software. “Memory” may store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Modifications, additions, or omissions may be made to network system portion 10 without departing from the scope of the invention. The components of network system portion 10 may be integrated or separated according to particular needs. Moreover, the operations of network system portion 10 may be performed by more, fewer, or other devices. Additionally, operations of network system portion 10 may be performed using any suitable logic. As used in this document, “each” refers to each member of a set or each member of a subset of a set.

FIG. 2 illustrates one embodiment of a network element 20 that may be used with network system portion 10 of FIG. 1. According to the illustrated embodiment, network element 20 has modules 24 that include a line card 40, a multiplexer-demultiplexer (mux-demux) 44, an optical switch 48, and an amplifier 52 coupled as shown. Line card 40 includes client facilities 60, switch fabric 64, network facilities 66, and edge ports (OCH) 70 coupled as shown. Mux-demux 44 includes a multiplexer 74 (with multiplexer ports 78) and a demultiplexer 80 coupled as shown. Optical switch 48 includes optical channel monitor 84. Amplifier 52 has amplifier ports (WCH) 88.

Line card 40 performs operations to communicate signals between client 28 and a network. Examples of operations include signal routing, signal aggregation and/or separation, analog-to-digital and/or digital-to-analog conversion, encoding and/or decoding, and/or signal transformation to satisfy different protocols. Examples of line cards 40 include transponders, muxponders, and flexponders.

A facility 60 or 66 supports traffic for a specific service. A facility 60 or 66 may allow for communication according to specific parameters, for example, format, protocol, rate of traffic, and/or other parameters. A client facility 60 supports communication with a particular client 28, and may be embodied as a small factor pluggable (SFP). Network facility 66 supports communication with the network system. Switch fabric 76 aggregates signals from client facilities 60 and/or separates signals destined for client facilities 60. Edge ports 70 communicate a signal of a particular channel to a particular port 78 of multiplexer 74.

Multiplexer 74 of mux-demux 44 multiplexes signals received from line card 40. A multiplexer port 78 receives a signal from a particular edge port 70. Demultiplexer 80 demultiplexes signals received from optical switch 48.

Optical switch 48 switches optical signals received from mux-demux 44. Optical channel monitor 84 monitors the signals from mux-demux 44. Optical channel monitor 84 may determine whether signals are being appropriately communicated on specific channels. Optical channel monitor 84 may also analyze signals to determine the quality of the signals.

Amplifier 52 amplifies signals received from optical switch 48. An amplifier port 88 receives a signal of a particular channel. Amplifier 52 may notify optical channel monitor 84 of whether a signal received at a particular port 88 has or has not been received.

Modifications, additions, or omissions may be made to network element 20 without departing from the scope of the invention. The components of network element 20 may be integrated or separated according to particular needs. Moreover, the operations of network element 20 may be performed by more, fewer, or other devices. Additionally, operations of network element 20 may be performed using any suitable logic.

FIG. 3 illustrates one embodiment of a method for establishing active/standby states from service readiness that may be used with network element 20 of FIG. 2. According to one embodiment, controller 34 may perform the method.

Steps 110 and 114 describe provisioning a path 32 for a service. Ports are mapped at step 110 to allow a signal to travel from point A to point B. In the illustrated embodiment, edge ports 70 are mapped to multiplexer ports 78, and switch ports 85 are mapped to amplifier ports 86. Ports are mapped to initiate monitoring by optical channel monitor 84 at step 114. In the illustrated embodiment, edge ports 70 may be mapped to amplifier ports 86.

A signal is introduced at input A at step 118. Optical channel monitor 84 monitors path 32 at step 122 to analyze and verify the signal. Other modules 24 may report conditions to optical channel monitor 84. For example, an amplifier port 88 may report that it is not receiving a signal.

If there is a condition at step 126, the method proceeds to step 130, where controller 34 attempts to resolve the condition. As an example, controller 34 may check the mappings of path 32. The method then returns to step 122, where optical channel monitor 84 continues to monitor path 32. If there is no condition at step 126, the method proceeds to step 236.

Controller 34 determines that the service is ready at step 138. Controller reports that the modules 24 are in an active state at step 140. Controller 34 reports that client facilities 60 and network facility 66 of line card 40 also are in an active state at step 144. After reporting the active states, the method terminates.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that service readiness of a network element may be used to determine the active/standby states for modules of the network element. A path for providing the service may be provisioned and monitored. When the service is ready, the modules of the path may be designated to have an active state. Another technical advantage of one embodiment may be that the facilities of a module of the path providing a service that is ready may also be determined to have an active state.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for determining an active/standby state of one or more modules of a network element, comprising:
provisioning a path through one or more modules of a network element, the path for providing a service;
introducing a signal into the path;
monitoring the path;
establishing that the service is ready in accordance with the monitoring; and
determining that the one or more modules are in an active state in response to establishing that the service is ready.

2. The method of claim 1, wherein provisioning the path through the one or more modules of the network element further comprises:
mapping a plurality of first ports of a first module of the one or more modules with a plurality of second ports of a second module of the one or more modules.

3. The method of claim 1, wherein provisioning the path through the one or more modules of the network element further comprises:
mapping a plurality of edge ports of a line card module of the one or more modules to a plurality of ports of a multiplexer module of the one or more modules.

4. The method of claim 1, wherein provisioning the path through the one or more modules of the network element further comprises:
provisioning to initiate monitoring of the path.

5. The method of claim 1, wherein provisioning the path through the one or more modules of the network element further comprises provisioning to initiate monitoring of the path by:
mapping a plurality of optical channel ports of a line card module of the one or more modules to a plurality of amplifier ports of an amplifier module of the one or more modules.

6. The method of claim 1, further comprising:
determining that one or more facilities of a module of the one or more modules are in an active state.

7. The method of claim 1, wherein establishing that the service is ready in accordance with the monitoring further comprises:
determining that there are one or more conditions; and
determining that the one or more conditions have been resolved.

8. A controller operable to determine an active/standby state of one or more modules of a network element, comprising:
a memory operable to:
store information describing one or more modules of a network element; and
one or more processors coupled to the memory, the one or more processors operable to:
provision a path through the one or more modules, the path for providing a service;
introduce a signal into the path;
monitor the path;
establish that the service is ready in accordance with the monitoring; and
determine that the one or more modules are in an active state in response to establishing that the service is ready.

9. The controller of claim 8, the one or more processors further operable to provision the path through the one or more modules of the network element by:
mapping a plurality of first ports of a first module of the one or more modules with a plurality of second ports of a second module of the one or more modules.

10. The controller of claim 8, the one or more processors further operable to provision the path through the one or more modules of the network element by:
mapping a plurality of edge ports of a line card module of the one or more modules to a plurality of ports of a multiplexer module of the one or more modules.

11. The controller of claim 8, the one or more processors further operable to provision the path through the one or more modules of the network element by:
provisioning to initiate monitoring of the path.

12. The controller of claim 8, the one or more processors further operable to provision the path through the one or more modules of the network element by provisioning to initiate monitoring of the path by:
mapping a plurality of optical channel ports of a line card module of the one or more modules to a plurality of amplifier ports of an amplifier module of the one or more modules.

13. The controller of claim 8, the one or more processors further operable to:
determine that one or more facilities of a module of the one or more modules are in an active state.

14. The controller of claim 8, the one or more processors further operable to establish that the service is ready in accordance with the monitoring by:
determining that there are one or more conditions; and
determining that the one or more conditions have been resolved.

15. Logic for determining an active/standby state of one or more modules of a network element, the logic embodied in a computer-readable medium and when executed by a computer operable to:
provision a path through one or more modules of a network element, the path for providing a service;
introduce a signal into the path;
monitor the path;
establish that the service is ready in accordance with the monitoring; and
determine that the one or more modules are in an active state in response to establishing that the service is ready.

16. The logic of claim 15, further operable to provision the path through the one or more modules of the network element by:
mapping a plurality of first ports of a first module of the one or more modules with a plurality of second ports of a second module of the one or more modules.

17. The logic of claim 15, further operable to provision the path through the one or more modules of the network element by:
mapping a plurality of edge ports of a line card module of the one or more modules to a plurality of ports of a multiplexer module of the one or more modules.

18. The logic of claim 15, further operable to provision the path through the one or more modules of the network element by:
provisioning to initiate monitoring of the path.

19. The logic of claim 15, further operable to provision the path through the one or more modules of the network element by provisioning to initiate monitoring of the path by:
mapping a plurality of optical channel ports of a line card module of the one or more modules to a plurality of amplifier ports of an amplifier module of the one or more modules.

20. The logic of claim 15, further operable to:
determine that one or more facilities of a module of the one or more modules are in an active state.

21. The logic of claim 15, further operable to establish that the service is ready in accordance with the monitoring by:
determining that there are one or more conditions; and
determining that the one or more conditions have been resolved.

22. A system for determining an active/standby state of one or more modules of a network element, comprising:
means for provisioning a path through one or more modules of a network element, the path for providing a service;
means for introducing a signal into the path;
means for monitoring the path;
means for establishing that the service is ready in accordance with the monitoring; and
means for determining that the one or more modules are in an active state in response to establishing that the service is ready.
